(19) United States
(12) Patent Application Publication
(10) Pub. No.: US 2003/0200133 A1
(43) Pub. Date: Oct. 23, 2003

(54) Network-based productivity forecast and responding system and method

(75) Inventors: Te-Mei Chu, Taipei (TW); Shu-Mei Chien, Taipei (TW); Yun-Chi Lee, Taipei (TW); Kuan-I Wu, Taipei (TW)

Correspondence Address: Finnegan, Henderson, Farabow,, Garrett & Dunner, L.L.P., 1300 I Street, N.W., Washington, DC, 20005-3315, US

(73) Assignee: INVENTEC CORPORATION

(21) Appl. No.: 10/226,218

(22) Filed: Aug. 23, 2002

(30) Foreign Application Priority Data
Apr. 19, 2002 (TW) 91108040

(51) Int. Cl. G06F 17/60

(52) U.S. Cl. 705/10

(57) ABSTRACT

A network-based productivity forecast and responding system and method is proposed, which is intended for use by a supplier and a manufacturer to exchange demand-and supply transaction information in a real-time online manner over a network system. The proposed system and method is characterized by the use of a server to serve up a productivity-forecast inquiry Web page and a productivity-forecast responding Web page, whereby the manufacturer can utilize the productivity-forecast inquiry Web page to post the manufacturer's demanded amount of material per day during a future period, allowing the supplier to acquire these data by linking via the network system to the productivity-forecast inquiry Web page and respond by using the productivity-forecast responding Web page. This allows the supplier to prepare well in advance to prevent oversupply or undersupply, and also allows the manufacturer to carry out purchase management more efficiently.

### BACKGROUND OF THE INVENTION

1. Field of the Invention

This invention relates to network-based information technology, and more particularly, to a network-based productivity forecast and responding system and method, which allows a supplier and a manufacturer to exchange productivity forecast data and related information in a real-time online manner over a network system, such as the Internet, so as to allow the supplier to prepare well in advance to prevent oversupply or undersupply and also allow the manufacturer to carry out purchase management more efficiently.

2. Description of Related Art

In the manufacture industry, such as the CEM (Contract Electronics Manufacture) industry, the manufacturer depends on a supplier for supply of components that are used for the assembly of various electronic products, such as computers. To allow the manufacture process to be highly efficient, it is an important task for the manufacturer to let the supplier fully aware of the manufacturer's future demand in material, such as the manufacturer's demanded amount of material per day during the period of the next 7 days or 14 days, so that the supplier can prepare well in advance to prevent oversupply or undersupply.

Conventional demand-and-supply transaction between manufacturer and supplier is carried out in such a manner that the manufacturer first calculates for its demanded amount of material per day during the period of the next 7 days or 14 days, and then forwards the related data of the demand in printed documents to the supplier. If the supplier can fully satisfy the manufacturer's demand, the supplier will respond by returning a verification response to the manufacturer; otherwise, the supplier will respond by informing the manufacturer of its actual supply capability. Conventionally, the supplier's response to the manufacturer's demand also relies on printed documents.

One drawback to the conventional paperwork-based transaction method, however, is that the use of printed documents for exchanging all the related transaction data is quite laborious and time-consuming and would not allow real-time exchange and update of the transaction data, making the demand-and-supply transaction between the manufacturer and the supplier unsatisfactorily inefficient.

### SUMMARY OF THE INVENTION

It is therefore an objective of this invention to provide a network-based productivity forecast and responding system and method, which allows a supplier and a manufacturer to exchange productivity-forecast data and related information in a real-time online manner so as to allow the demand-and-supply transaction between the manufacturer and the supplier to be more efficient.

The network-based productivity forecast and responding system and method of the invention is intended for use by a supplier and a manufacturer to exchange demand-and supply transaction information in a real-time online manner over a network system, such as Internet or an extranet system.

The network-based productivity forecast and responding system and method of the invention is characterized by the use of a server to serve up an online purchase management system including a productivity-forecast inquiry Web page and a productivity-forecast responding Web page, whereby the manufacturer can utilize the productivity-forecast inquiry Web page to post the manufacturers demanded amount of material per day during a future period, allowing the supplier to gain access to these data by linking via the network system to the productivity-forecast inquiry Web page and respond to the manufacturer's demand by using the productivity-forecast responding Web page. This allows the supplier to prepare well in advance to prevent oversupply or undersupply, and also allows the manufacturer to carry out purchase management more efficiently.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the system architecture of the network-based productivity forecast and responding system according to the invention;

FIG. 2A shows an example of a productivity-forecast inquiry Web page provided by the network-based productivity forecast and responding system and method according to the invention;

FIG. 2B shows an example of a productivity-forecast responding Web page provided by the network-based productivity forecast and responding system and method according to the invention; and

FIG. 3 is a flow diagram showing the procedural steps carried out by the network-based productivity forecast and responding system and method according to the invention.

### DETAILED DESCRIPTION OF PREFERRED EMBODIMENTS

The network-based productivity forecast and responding system and method according to the invention is disclosed in full details by way of preferred embodiments in the following with reference to the accompanying drawings.

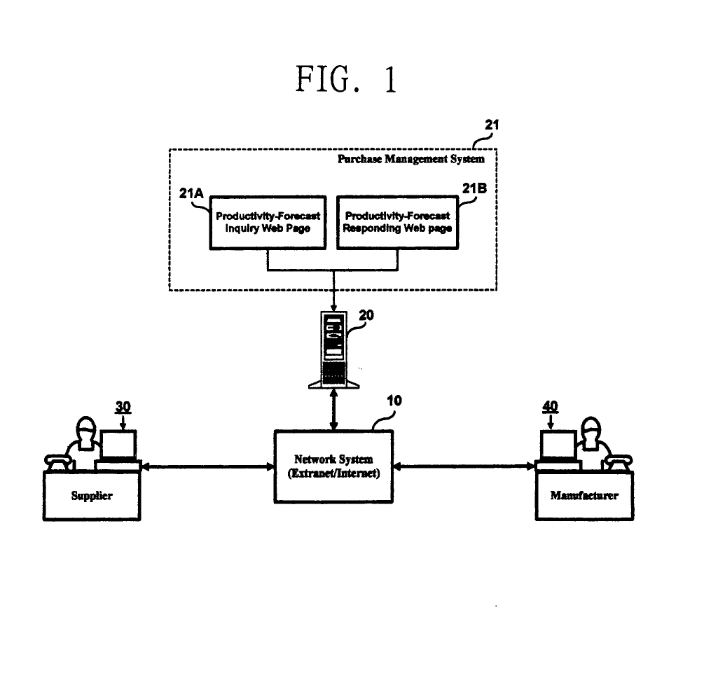

FIG. 1 is a schematic diagram showing the system architecture of the network-based productivity forecast and responding system according to the invention. As shown, the network-based productivity forecast and responding system of the invention comprises: (a) a network system 10; (b) a server 20; (c) at least one first-party workstation 30; and (d) at least one second-party workstation 40, and which is intended for use by a supplier (i.e., the first party) and a manufacturer (i.e., the second party) to exchange transaction data in a real-time online manner over the network system 10.

The network system 10 can be Internet or an extranet system dedicatedly established between the supplier and the manufacturer, and which is linked to the server 20, the first-party workstation 30, and the second-party workstation 40 to allow the server 20, the first-party workstation 30, and the second-party workstation 40 to exchange data therethrough.

The server 20 is linked to the network system 10 and is used to serve up an online purchase management system 21 which includes a productivity-forecast inquiry Web page 21A and a productivity-forecast responding Web page 21B. Any authorized workstations (i.e., the first-party workstation 30 and the second-party workstation 40) can gain access to the productivity-forecast inquiry Web page 21A and the productivity-forecast responding Web page 21B by linking via the network system 10 to the server 20.

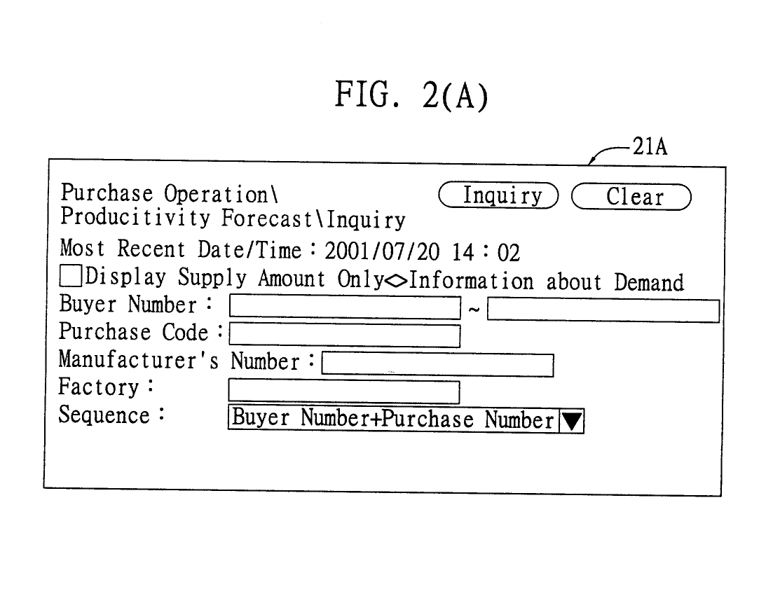

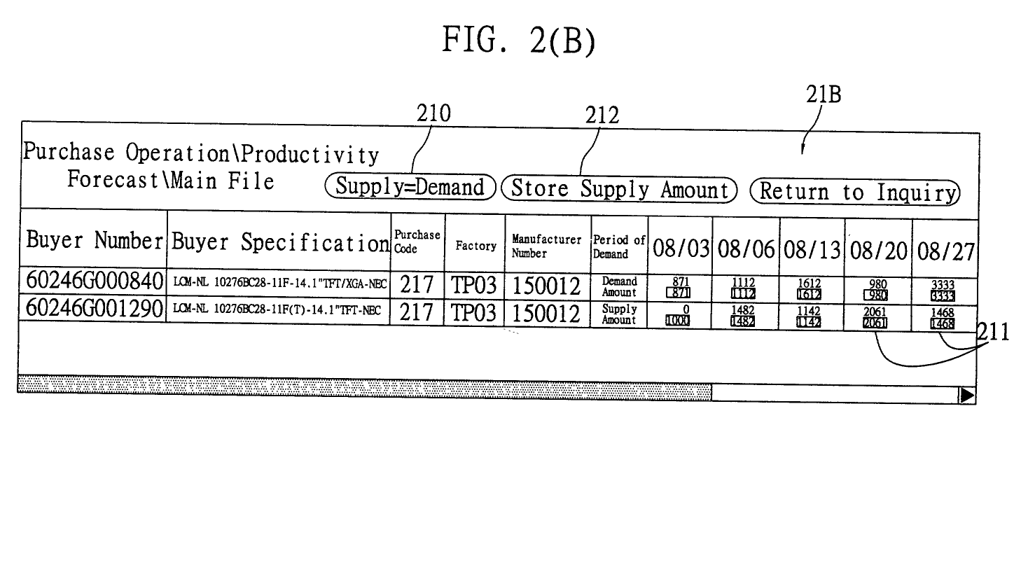

FIG. 2A shows an example of the productivity-forecast inquiry Web page 21A, which allows the user (i.e., a taskforce member on either the supplier side or the manufacturer side) to learn the manufacturer's demanded amount of material per day during a future period, such as during the period of the next 7 days or 14 days.

FIG. 2B shows an example of the productivity-forecast responding Web page 21B, which allows the user (i.e., a taskforce member on the supplier side) to respond to the manufacturer's demand about the supplier's actual supply capability.

The first-party workstation 30 is a computer unit on the supplier's side, which can utilize a Web browser program, such as Microsoft Internet Explorer or Netseape Navigator, to link via the network system 10 to the purchase management system 21 on the server 20 for the purpose of browsing the contents of the productivity-forecast inquiry Web page 21A or the productivity-forecast responding Web page 21B.

The second-party workstation 40 is a computer unit on the manufacturer's side, which utilize a Web browser program, such as Microsoft Internet Explorer or Netscape Navigator, to link via the network system 10 to the purchase management system 21 on the server 20 for the purpose of browsing the contents of the productivity-forecast inquiry Web page 21A or the productivity-forecast responding Web page 21B. In one preferred embodiment of the invention, for example, the second-party workstation 40 is integrated to an ERP (Enterprise Resource Planning) system installed on the manufacturer's side.

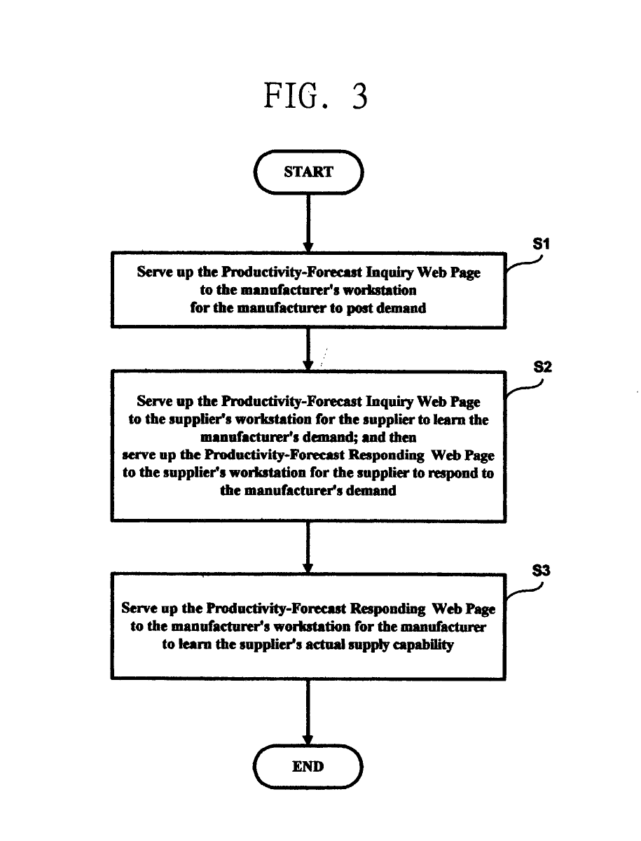

FIG. 3 is a flow diagram showing the procedural steps carried out by the network-based productivity forecast and responding system and method according to the invention for the manufacturer and the supplier to exchange transaction information.

As shown, in the first step S1, the manufacturer utilizes the second-party workstation 40 in its internal ERP system to link via the network system 10 to the purchase management system 21 on the server 20, and then post the related data of the manufacturer's demanded amount of material per day during a future period, such as during the period of the next 7 days or 14 days, on the productivity-forecast inquiry Web page 21A. This allows all management taskforce members on both the manufacturer side and the supplier side to gain access to the related data of the manufacturer's demanded amount of material by linking their workstations (i.e., the first-party workstation 30 and the second-party workstation 40) via the network system 10 to the purchase management system 21 on the server 20 and use a Web browser program, such as Microsoft Internet Explorer or Netscape Navigator to browse the contents of the productivity-forecast inquiry Web page 21A.

In the next step S2, the supplier utilizes the first-party workstation 30 to link via the network system 10 to the purchase management system 21 on the server 20 and use the Web browser program on the first-party workstation 30 to browse the contents of the productivity-forecast responding Web page 21B to learn the manufacturer's demanded amount of material per day during the period of the next 7 days or 14 days. If the supplier can fully satisfy the manufacturer's demand, the supplier can promptly respond by switching to the productivity-forecast responding Web page 21B and give a verification response by, for example, clicking on the [Supply=Demand] button 210 in the productivity-forecast responding Web page 21B; and whereas if the supplier's actual supply capability is less than the manufacturer's demand, the supplier can input the amount of its actual supply capability into the data field 211 in the productivity-forecast responding Web page 21B and then click on the [Store Supply Amount] button 212.

In the next step S3, as the supplier completes its response via the productivity-forecast responding Web page 21B, it then allows the manufacturer to utilize the second-party workstation 40 to gain access via the network system 10 to the purchase management system 21 on the server 20 and use the Web browser program to browse the supplier's response in the productivity-forecast responding Web page 21B which indicates the supplier's actual supply capability to the manufacturer's demand. It is to be noted that, although the manufacturer can link to the productivity-forecast responding Web page 21B, no one on the manufacturer side is authorized to alter the contents of the data field 211 in the productivity-forecast responding Web page 21B. In the case of the supplier's actual supply capability is less than the manufacturer's demand, the manufacturer can promptly seek other supply sources to supplement the deficiency.

In conclusion, the invention, provides a network-based productivity forecast and responding system and method for use by a manufacturer and a supplier to exchange information about the demand-and-supply transaction therebetween, which is characterized by the use of a server to serve up a productivity-forecast inquiry Web page and a productivity-forecast responding Web page, whereby the manufacturer can utilize the productivity-forecast inquiry Web page to post the manufacturer's demanded amount of material per day during a future period, allowing the supplier to promptly gain access to these data by linking via Internet to the productivity-forecast inquiry Web page and respond to the manufacturer's demand by using the productivity-forecast responding Web page. This allows the supplier to prepare well in advance to prevent oversupply or undersupply, and also allows the manufacturer to carry out purchase management more efficiently.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A network-based productivity forecast and responding system for use by a manufacturer and a supplier to exchange demand-and-supply transaction information in an online manner via a network system linked to a first-party workstation on the supplier side and a second-party workstation on the manufacturer side;
the network-based productivity forecast and responding method comprising:
(1) providing a server linked to the network system to serve up an online purchase management system including a productivity-forecast inquiry Web page and a productivity-forecast responding Web page;
(2) serving up the productivity-forecast inquiry Web page via the network system to the second-party workstation on the manufacturer side, allowing the manufacturer to post related data of the manufacturer's demanded amount of material per day during a future period;
(3) serving up the productivity-forecast inquiry Web page via the network system to the first-party workstation on the supplier side, allowing the supplier to learn the manufacturer's demanded amount of material in the future;
(4) serving up the productivity-forecast responding Web page via the network system to the first-party workstation on the supplier side, allowing the supplier to respond to the manufacturer's demand by specifying the supplier's actual supply capability; and
(5) serving up the productivity-forecast responding Web page via the network system to the manufacturer's second-party workstation, allowing the manufacturer to learn the supplier's actual supply capability.

2. The method of claim 1, wherein the network system is selected from the types comprising Internet and extranet system.

3. The method of claim 1, wherein the first-party workstation and the second-party workstation each utilizes a Web browser program to link to the productivity-forecast inquiry Web page and the productivity-forecast responding Web page in the purchase management system.

4. The method of claim 3, wherein the Web browser program is Microsoft Internet Explorer.

5. The method of claim 3, wherein the Web browser program is Netscape Navigator.

6. The method of claim 1, further comprising:
serving up the productivity-forecast inquiry Web page via the network system to the second-party workstation, allowing the manufacturer to learn its own demanded amount of material per day during the future period.

7. A network-based productivity forecast and responding system for use by a manufacturer and a supplier to exchange demand-and-supply transaction information in an online manner;
the network-based productivity forecast and responding system comprising:
(a) a network system;
(b) a server, which is linked to the network system, and which is used to serve up an online purchase management system including a productivity-forecast inquiry Web page and a productivity-forecast responding Web page;
(c) at least one first-party workstation, which is installed on the supplier side, and which is linkable via the network system to the server; and
(d) at least one second-party workstation, which is installed on the manufacturer side, and which is linkable via the network system to the server;
wherein
the manufacturer utilizes the second-party workstation to link via the network system to the server to post the related data of the manufacturer's demanded amount of material per day during a future period on the productivity-forecast responding Web page;
the supplier utilizes the first-party workstation to link via the network system to the purchase management system on the server to gain access to the productivity-forecast inquiry Web page to acquire the data of the manufacturer's demanded amount of material in the future; and
the supplier further links to the productivity-forecast responding Web page to respond to the manufacturer's demand by specifying the supplier's actual supply capability, allowing the manufacturer to learn the supplier's actual supply capability by linking via the network system to the productivity-forecast responding Web page.

8. The network-based productivity forecast and responding system of claim 7, wherein the network system is selected from the types comprising Internet and extranet system.

9. The network-based productivity forecast and responding system of claim 7, wherein the first-party workstation and the second-party workstation each utilizes a Web browser program to link to the productivity-forecast inquiry Web page and the productivity-forecast responding Web page in the purchase management system.

10. The network-based productivity forecast and responding system of claim 9, wherein the Web browser program is Microsoft Internet Explorer.

11. The network-based productivity forecast and responding system of claim 9, wherein the Web browser program is Netscape Navigator.

12. The network-based productivity forecast and responding system of claim 7, wherein the manufacturer can link to the productivity-forecast inquiry Web page, allowing the manufacturer to learn its own demanded amount of material per day during the future period.
